(19) United States
(12) Patent Application Publication
(10) Pub. No.: US 2005/0283806 A1
(43) Pub. Date: Dec. 22, 2005

(54) Method and apparatus for displaying user interface embedded applications on a mobile terminal or device

(75) Inventor: Marko M. Torvinen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/871,958

(22) Filed: Jun. 18, 2004

(51) Int. Cl. H04N 7/16

(52) U.S. Cl. 725/62; 725/81

(57) ABSTRACT

A method and apparatus for providing content on a display of a mobile terminal or device featuring displaying a user interface embedded application having a selected type of information or content and viewing configurability of the same, including either user-defined content placement, size, activation time or some combination thereof. The selected type of wireless information or content includes wireless information or content provided from a connection to a network, including the GPRS or Internet. The viewing configurability is relational to different views or menus provided on the display. The wireless information or content includes real time content, such as stock exchange information, visual radio, a video stream of home security, childcare, or other suitable video stream.

### BACKGROUND OF THE INVENTION

1. Field of Invention

The present invention relates to the area of personalized application usage and user configurable user interfaces in a mobile environment; and more particularly to a method and apparatus for displaying content on a mobile terminal or device, especially for displaying one or more user interface (UI) embedded applications on a display of such a mobile terminal or device.

2. Description of Related Art

In many situations during the course of a day, a user of a mobile terminal or device may want to view and/or monitor relevant information about a certain area or group and make the relevant information easily available and immediately and continuously viewable in an end user defined personalized context(s). In particular, a user may access certain types of information or content, including wireless information or content from the Internet, photographic images, short messaging services (SMS) messages, etc. However, typically, the user has to open a totally separate application each time they want to access such relevant information, and thus may not notice changes thereto as soon as possible. Moreover, the user does not have the ability to display this information or content on the display of their mobile phone or terminal in a personalized user-defined configurable way for viewing the information or content with a certain placement or location, with a certain size and/or at a certain activation time on the display of their mobile terminal or device.

Wireless information or content from the Internet, photographic images, short messaging services (SMS) messages, etc. are displayed on the display of the mobile terminal or device in a predetermined manner, which is not subject to user configurability or re-configurability.

In addition, other types of information or content is also displayed on a mobile terminal or device. For instance, a WallpaperChanger program or application is known in the art and is merely used for displaying a restricted group of applications that can be run as a whole background display of a mobile device or terminal device. In comparison, a Smartclock program or application is merely restricted to displaying only a clock and calendar. The placement, size and activation time of the information or content from the WallpaperChanger or Smartclock programs cannot be changed or configured by the user. Moreover, neither the WallpaperChanger or Smartclock programs provide the possibility that the application uses GPRS or other communications means on a network to get real time content, e.g. stock rates to the phone for the embedded application, and displaying the same in a user defined manner in relation to the normal menu of the mobile phone or device.

For a long time, there has been no method or apparatus for providing the user of a mobile terminal or device with the ability to view and monitor relevant wireless information or content in such a user-configurable manner. The present invention provides a new and unique way to address this long felt need in the art and provide a solution thereto.

### SUMMARY OF INVENTION

The basic idea of the present invention is to provide an end user with the ability to define within their mobile terminal or device user interface (UI) embedded applications that they want to be active and embedded into the user interface of the mobile terminal or device. This kind of active UI embedded application may include for example:
1) Stock exchange information,
2) Visual radio,
3) Presence information (e.g. chosen buddy list),
4) Location information (e.g. chosen notifications),
5) Home related information (who is using home network, sign onto it) and
6) Video stream, such as home security, childcare etc.

The basic idea of the present invention is that the user-defined selected information or content may always be visible on the mobile terminal or device so that the end user can very easily monitor the information or content of an active application, including viewing the information or content in a certain placement, with a certain size and at a certain activation time on the display of their mobile terminal or device.

The present invention will create the possibility to have active content on the terminal screen while still be able to use the mobile terminal or device normally by defining placement schemes for UI embedded applications. This would be a major benefit for those users, who feel that it is important for them to be aware of certain user relevant information all the time.

For example, in a known Series 60 terminal, active content of the UI embedded applications can be placed on the main view to replace traditional pictures. In a known devices, such as the Nokia Series 90 terminal and Communicators, the UI embedded application can replace permanently a part of the screen to enable flexible working while still have relevant content visible.

In contrast to the prior art, where accessing separate applications required an end user to constantly access each application which is burdensome, with the present invention it is easy for the end user to monitor relevant information and activate it only when there is need for it.

The present invention is about enabling the configuration of applications running in the UI so that they are easily viewable. The user can define how the application is viewed when the application is embedded in the UI. The user can define the size of the application, and the embedded application can be relational to different views or menus.

The present invention makes it possible to present the user desired information easily. The advantage over the prior art is that the user will not have to switch between applications when this invention is used.

Important features of the present invention include the fact that the one or more embedded applications are user configurable, that the embedded application may have a connection to the network, and that the mobile terminal or device has a user interface that enables configurability.

In effect, the present invention creates the following benefits and advantages:

1) It creates the possibility to have active content on the terminal screen while still being able to use the mobile terminal or device normally. This would be a major benefit for those users, who feel that it is important for them to be aware of certain user relevant information all the time.

2) The UI embedded application of the present invention can contain relevant active information to end users, as follows:
a) In the known Series 60 terminal, active content of UI embedded applications may be placed on the main view to replace traditional pictures.
b) In the known Series 90 and Communicators, the UI embedded application, according to the present invention, may replace permanently a part of the display or screen to enable flexible working while still have relevant content visible (e.g. listening of the visual radio and seeing it's content).

3) With UI embedded applications it is easy for an end user to monitor relevant information and activate it only when there is a need for it.

In summary, the present invention provides a new and unique method and apparatus for providing content on a display of a mobile terminal or device that features displaying a user interface embedded application having a selected type of content and viewing configurability of the same, including either user-defined content placement, size, activation time or some combination thereof. The apparatus may include a mobile terminal or device having a user interface embedded application for displaying the user interface embedded application, a network having such a mobile terminal or device, as well as a computer program product with a program code that is stored on a machine readable carrier, for carrying out the steps according to the aforementioned method when the computer program is run in a processor or controller of the mobile terminal or device.

The present invention is intended to include providing a viewing configurability that is relational to different views or menus provided on the display, as well as providing real time wireless content, such as stock exchange information, visual radio, a video stream of home security, child care, or other suitable video stream. The content may always be visible on the display, or visible on one part of the display, while a normal menu is visible on another part of the display. The content may be visible during one or more predefined menus. The viewing configurability may depend on the type of content being displayed. The viewing configurability of one type of content may be configurable one way, while the viewing configurability of another type of content may be configurable another way. The content may be real time content that is displayed so the user can monitor the same. The content may also include selected information that is always displayed and other information that is not always displayed, as well as different types of wireless content, each having a respective viewing configurability. The wireless content may be displayed as a background view in place of wallpaper/picture images, displayed in a permanent placement or displayed in a relational placement.

### BRIEF DESCRIPTION OF THE DRAWING

The drawing, not drawn to scale, includes the following Figures:

FIG. 1 shows a diagram of a network having a mobile terminal or device according to the present invention.

FIG. 2 shows a diagram of a mobile terminal or device shown in FIG. 1 according to the present invention.

FIG. 3 shows two diagrams UI embedded active stock quotation applications displayed according to the present invention, including FIG. 3a having a first active stock quotation display and FIG. 3b having a larger active stock quotation display.

FIG. 4 includes a diagram of a visual radio as part of a work screen view of a device according to the present invention.

FIG. 5 includes a diagram of a visual workgroup presence as part of a work screen view of another device according to the present invention.

### DETAILED DESCRIPTION OF INVENTION

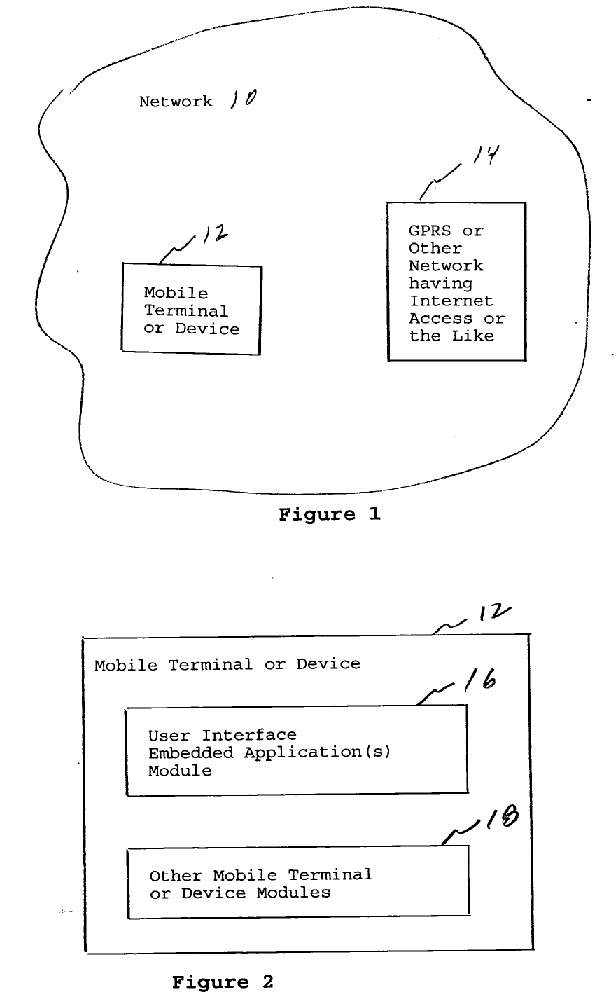

FIG. 1 shows a network generally indicated as 10 having a mobile terminal or device 12 and a General Packet Radio Services (GPRS) or other network having Internet access or the like. The whole thrust of the invention relates to displaying on the mobile terminal or device 12 one or more user interface (UI) embedded applications having a selected type of content and viewing configurability of the same, including either user-defined content placement, size, activation time or some combination thereof. The network 10 is shown having one mobile terminal or device 12, but would typically include multiple mobile terminal or devices having the ability to display such a UI embedded application according to the present invention. The information or content may include wireless information or content that is understood to be information or content provided from one node in a wireless network to another node in the wireless network. The scope of the invention is not intended to be limited to the type or kind of information or content, or the type or kind of node sending or receiving the wireless information or content.

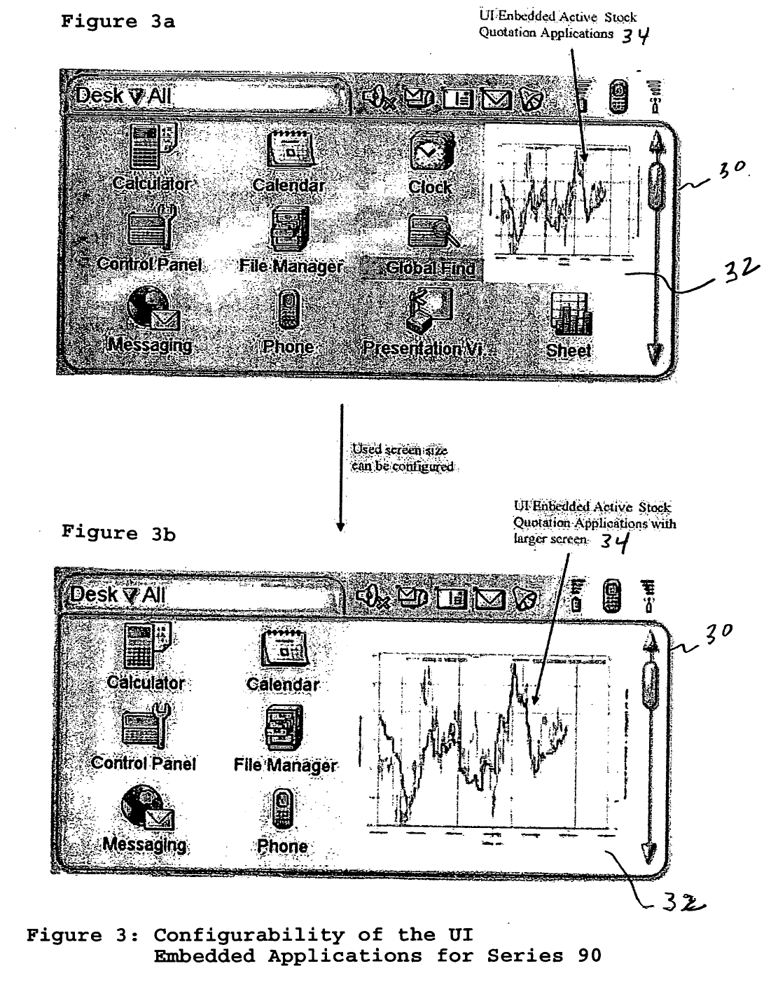

FIG. 2 shows, by way of example, the mobile terminal or device 12 having a UI embedded application module 16 and other mobile terminal or device modules 18. The UI embedded application module 16 displays on the mobile terminal or device 12 the one or more user interface (UI) embedded applications having the selected type of content and viewing configurability of the same, including either user-defined content placement, size, activation time or some combination thereof, which will be shown and described in more detail in relation to FIGS. 3-5. The functionality of the mobile terminal or device 12 may be implemented alone or in combination using hardware, software, firmware, or a combination thereof. In a typical software implementation, the module 16 would be one or more microprocessor-based architectures having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The scope of the invention is not intended to be limited to any particular implementation using technology known or later developed in the future.

According to the present invention, the selected type of information or content may include wireless information or content provided from a connection to the network 14 (FIG. 1), including the GPRS, Internet or other network having Internet access or the like.

The other mobile terminal or device modules 18 may include other modules typically in a mobile terminal or device that are known in the art but do not necessarily form part of the basic invention disclosed herein, including a keyboard module, a memory module, input/output modules, a control module, etc.

Particular Implementations and/or Applications FIG. 3 shows a mobile device 30 providing on a display 32 an example of a user interface (UI) embedded application 34 having a selected type of content in the form of a graph of an active stock and having a viewing configurability of the same in the form a user-defined placement, size and/or activation time of the same. As shown in FIG. 3a, the graph of the active stock is shown in the righthand corner of the display 32. In comparison, as shown in FIG. 3b, the user may change the configurability so the graph of the active stock is shown in a larger format on the righthand side corner of the display 32. There are many different placement options, including two basic options:

1) Permanent placement within the UI (always placed at the same place within the UI when the end user changes view/menu).

2) Relational placement (UI embedded application is visible only within certain view(s)/menu(s)).

It is important to note that the scope of the invention is not intended to be limited to any particular user-defined placement, size and/or activation time of the information or content in the UI embedded application according to the present invention. In either case, the remainder of the display 32 includes the normal menu having known icons, including “Calculator,” “Calendar,” etc.

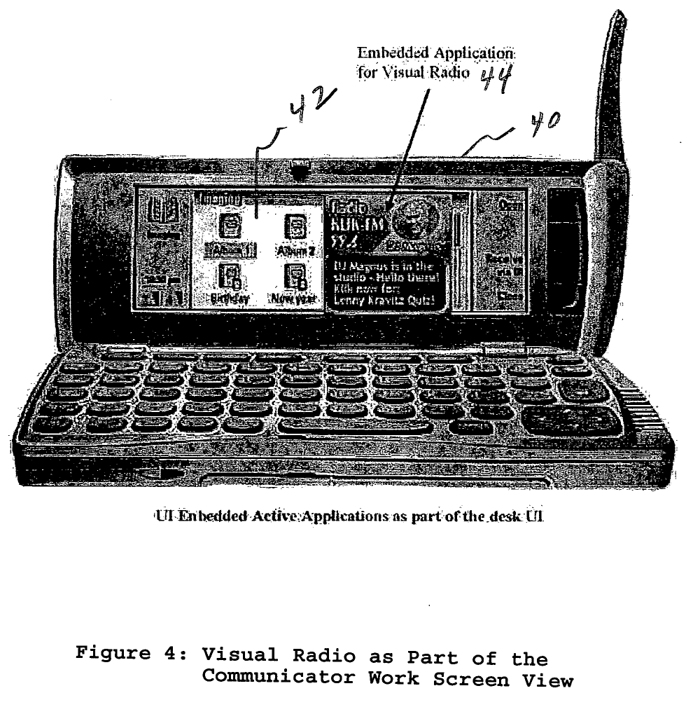

FIG. 4 shows a mobile device 40 providing on a display 42 an example of a user interface (UI) embedded application 44 having a selected type of content in the form of visual radio and having a viewing configurability of the same in the form a user-defined placement, size and/or activation time of the same. In FIG. 4, the visual radio is shown in the righthand side of the display 42. The remainder of the display 42 includes part of a menu having icons, including “Imaging,” “Album1,” “Album2,” etc.

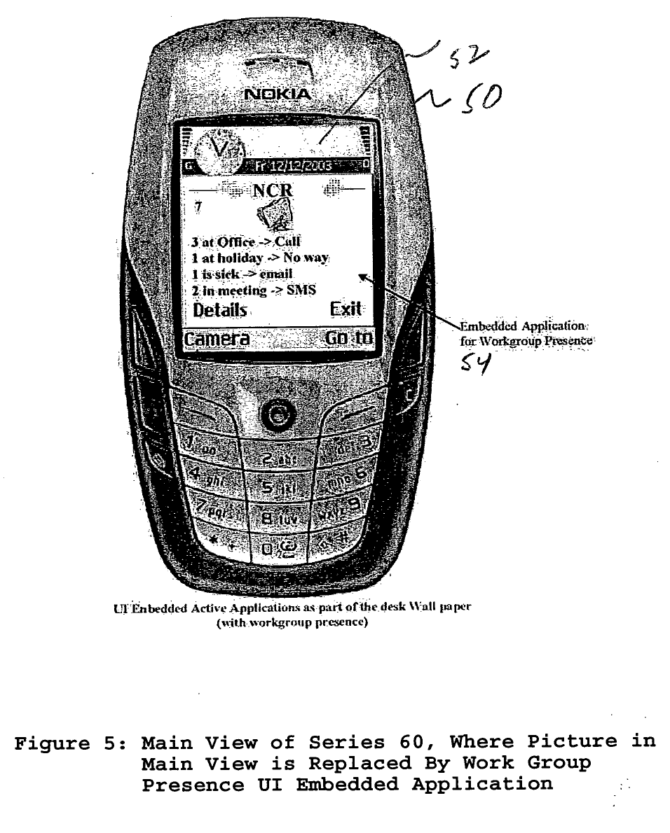

FIG. 5 shows a mobile device 50 providing on a display 52 an example of a user interface (UI) embedded application 54 having a selected type of content in the form of a workgroup presence and having a viewing configurability of the same in the form a user-defined placement, size and/or activation time of the same. In FIG. 5, the workgroup presence is shown as part of the desk wall paper in the display 52, and the main menu is otherwise not effected.

In summary, consistent with that described above, the present invention enables the following cases for UI Embedded Applications:

1) Visual Radio: UI embedded applications enable, e.g. a device such as an S90/Communicator, so that one can work while listening to radio and being able to see content of the visual radio content, to participate in radio voting related applications, quizzes, etc.

2) Presence information:
a. Teenagers and youths, who want to have presence data of their subscribed friends to be easily available.
b. Family members in many cases want to check other's whereabouts (location).
c. In an enterprise domain, there exists a huge demand for enterprise presence applications. (For example, a manager of a group can easily monitor chosen presence statuses of a given work group (e.g. location, reachability, other statuses include “at office,” “on sick leave,” etc.)).

3) Video stream: An end user can monitor, for example, if a baby is sleeping while doing gardening outside.

4) Stock exchange information: A busy business manager can monitor changing exchange rates actively while working with a terminal (e.g. emails) by opening a related web page.

5) Location information: An end user can actively see where he/she is on a map while not needing to open the terminal separately.

### SCOPE OF THE INVENTION

The scope of the invention is not intended to be limited to any specific kind of receiving node, user equipment, mobile terminal, phone or devices, and many different mobile terminals or device, including laptop or notebook computers, as well as PDAs and tablet PCs, are envisioned that may contain the fundamental features of the present invention described herein.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method of providing content on a display of a mobile terminal or device characterized in that the method comprises:
displaying a user interface embedded application having a selected type of information or content and viewing configurability of the same, including either user-defined content placement, size, activation time or some combination thereof.

2. A method according to claim 1, wherein the selected type of information or content includes wireless information or content provided from a connection to a network, including the GPRS or Internet.

3. A method according to claim 1, wherein the viewing configurability is relational to different views or menus provided on the display.

4. A method according to claim 1, wherein the wireless information or content includes real time content.

5. A method according to claim 1, wherein the information or content is always visible on the display.

6. A method according to claim 1, wherein the information or content is visible on one part of the display and a normal menu is visible on another part of the display.

7. A method according to claim 1, wherein the information or content is visible during one or more predefined menus.

8. A method according to claim 1, wherein the viewing configurability depends on the type of information or content being displayed.

9. A method according to claim 4, wherein the real time content includes stock exchange information, visual radio, a video stream of home security, child care, or other suitable video stream that is displayed so the user can monitor the same.

10. A method according to claim 1, wherein the information or content includes selected information that is always displayed and other information that is not always displayed.

11. A method according to claim 1, wherein the information or content includes different types of information or content, each having a respective viewing configurability.

12. A method according to claim 1, wherein the information or content is displayed as a background view in place of wallpaper/picture images.

13. A method according to claim 1, wherein the information or content is displayed in a permanent placement.

14. A method according to claim 1, wherein the information or content is displayed in a relational placement.

15. A mobile terminal or device that provides content on a display characterized in that the mobile terminal or device comprises:
a user interface embedded application module for displaying a user interface embedded application having a selected type of information or content and viewing configurability of the same, including either user-defined content placement, size, activation time or some combination thereof.

16. A mobile terminal or device according to claim 15, wherein the selected type of information or content includes wireless information or content provided from a connection to a network, including the GPRS or Internet.

17. A mobile terminal or device according to claim 15, wherein the viewing configurability is relational to different views or menus provided on the display.

18. A mobile terminal or device according to claim 15, wherein the information or content includes real time content.

19. A mobile terminal or device according to claim 15, wherein the information or content is always visible on the display.

20. A mobile terminal or device according to claim 15, wherein the information or content is visible on one part of the display and a normal menu is visible on another part of the display.

21. A mobile terminal or device according to claim 15, wherein the information or content is visible during one or more predefined menus.

22. A mobile terminal or device according to claim 15, wherein the viewing configurability depends on the type of information or content being displayed.

23. A mobile terminal or device according to claim 18, wherein the real time content includes stock exchange information, visual radio, a video stream of home security, child care, or other suitable video stream that is displayed so the user can monitor the same.

24. A mobile terminal or device according to claim 15, wherein the information or content includes selected information that is always displayed and other information that is not always displayed.

25. A mobile terminal or device according to claim 15, wherein the information or content includes different types of information or content, each having a respective viewing configurability.

26. A mobile terminal or device according to claim 15, wherein the information or content is displayed as a background view in place of wallpaper/picture images.

27. A mobile terminal or device according to claim 15, wherein the information or content is displayed in a permanent placement.

28. A mobile terminal or device according to claim 15, wherein the information or content is displayed in a relational placement.

29. A network having a mobile terminal or device that provides content on a display characterized in that the mobile terminal or device comprises:
a user interface embedded application module for displaying a user interface embedded application having a selected type of information or content and viewing configurability of the same, including either user-defined content placement, size, activation time or some combination thereof.

30. A network having a mobile terminal or device according to claim 29, wherein the selected type of information or content includes wireless information or content provided from a connection to a network, including the GPRS or Internet.

31. A network having a mobile terminal or device according to claim 29, wherein the viewing configurability is relational to different views or menus provided on the display.

32. A network having a mobile terminal or device according to claim 29, wherein the information or content includes real time content.

33. A network having a mobile terminal or device according to claim 29, wherein the information or content is always visible on the display.

34. A network having a mobile terminal or device according to claim 29, wherein the information or content is visible on one part of the display and a normal menu is visible on another part of the display.

35. A network having a mobile terminal or device according to claim 29, wherein the information or content is visible during one or more predefined menus.

36. A network having a mobile terminal or device according to claim 29, wherein the viewing configurability depends on the type of information or content being displayed.

37. A network having a mobile terminal or device according to claim 32, wherein the real time content includes stock exchange information, visual radio, a video stream of home security, child care, or other suitable video stream that is displayed so the user can monitor the same.

38. A network having a mobile terminal or device according to claim 29, wherein the information or content includes selected information that is always displayed and other information that is not always displayed.

39. A network having a mobile terminal or device according to claim 29, wherein the information or content includes different types of information or content, each having a respective viewing configurability.

40. A network having a mobile terminal or device according to claim 29, wherein the information or content is displayed as a background view in place of wallpaper/picture images.

41. A network having a mobile terminal or device according to claim 29, wherein the information or content is displayed in a permanent placement.

42. A network having a mobile terminal or device according to claim 29, wherein the information or content is displayed in a relational placement.

43. A method according to claim 1, wherein the method further comprises implementing the step of the method via a computer program running in a processor or controller in the mobile terminal or device.

44. A computer program product with a program code, which program code is stored on a machine readable carrier, for carrying out steps of a method of providing content on a display of a mobile terminal or device, including displaying a user interface embedded application having a selected type of information or content and viewing configurability of the same, including either user-defined content placement, size, activation time or some combination thereof, when the computer program is run in a processor or control module of the mobile terminal or device.
